(19) United States
(12) Patent Application Publication
(10) Pub. No.: US 2012/0079408 A1
(43) Pub. Date: Mar. 29, 2012

(54) SYSTEMS AND METHODS FOR GENERATING A SWIMLANE TIMELINE FOR TASK DATA VISUALIZATION

(75) Inventor: Daniel Rohwer, Northfield, MN (US)

(73) Assignee: VISIBILITY, BIZ. INC., EAGAN, MN (US)

(21) Appl. No.: 12/890,521

(22) Filed: Sep. 24, 2010

(51) Int. Cl. G06F 3/048

(52) U.S. Cl. 715/772

(57) ABSTRACT

A Swimlane Timeline Application for task data visualization utilizes a Microsoft Visio Application Programming Interface (API) to visualize task data. The task data includes one or more of: task name, task outline number, task start date, and/or task finish date. The application solicits, interprets, and visualizes the data by either mapping the user selected top-level outline number “n” as the parent task that defines the timeline and title, the “n.n” child tasks to swimlane rows, and the “n.n.n . . . ” lower level tasks to intervals and milestones within the swimlanes, or by utilizing the user selected group-by field to determine swimlanes, the user selected filter-by fields to determine timeline start and finish dates, and the user selected sort-by fields to determine task ordering. Task analysis and reporting are enhanced with features including task drill-in, task filter-by-value, task resource views, task date markers, swimlane timeline pagination, and other user visualization preferences.

### RELATED APPLICATIONS

The present application is related to U.S. patent application Ser. No. 12/316,084, filed Dec. 9, 2008, which is hereby incorporated by reference in its entirety.

### LIMITED COPYRIGHT WAIVER

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever. Copyright 2007, 2010, Visibility.biz, Inc.

### FIELD

Embodiments of the inventive subject matter relate generally to applications to display task data, and more particularly to generating a swimlane timeline for task data.

### BACKGROUND

Companies often use project management software to visualize time estimates and progress of projects. One useful visualization mechanism is the swimlane timeline in which various tasks associated with a project, or portfolio of projects, are placed in vertically stacked horizontal lanes referred to as “swimlanes”.

### BRIEF DESCRIPTION OF THE FIGURES

Embodiments of the invention are illustrated by way of example and not limitation in the Figures of the accompanying drawings in which:

FIG. 1 is a block diagram illustrating various components of a swimlane generation application and an example process flow with task data records input, and a swimlane timeline visualization output according to embodiments of the invention.

FIG. 2 illustrates an example swimlane timeline according to embodiments of the invention.

FIG. 3 illustrates an example drawing generation and source file selection dialogue used in embodiments of the invention.

FIG. 4 illustrates an example primary and secondary color palette configuration dialogue used in embodiments of the invention.

FIG. 5 illustrates an example multi-project portfolio view according to embodiments of the invention.

FIG. 6 illustrates an example of Shape Data associated with a selected task according to embodiments of the invention.

FIG. 7 illustrates an example multi page drill-in swimlane timeline according to embodiments of the invention.

FIG. 8 illustrates an example portfolio view showing percent complete visualization and shape data properties according to embodiments of the invention.

FIG. 9 illustrates an example bi-directional hyperlink automatically created with drill-in according to embodiments of the invention.

FIG. 10 illustrates an example Microsoft Office Project source file tasks highlighting unique outline numbers used by the Swimlane Timeline Application to create a default swimlane timeline visualization according to embodiments of the invention.

FIG. 11 illustrates an example Microsoft Office Excel source file used to create a swimlane timeline visualization hierarchy according to embodiments of the invention.

FIG. 12 illustrates an example Microsoft Office SharePoint Task List highlighting unique outline numbers used to create a swimlane timeline hierarchy.

FIG. 13 illustrates an example of the shapes used in a swimlane timeline according to embodiments of the invention.

FIG. 14 illustrates an example of Visio layer properties used by embodiments of the invention.

FIG. 15 illustrates a thin interval style for a swimlane timeline diagram according to embodiments of the invention.

FIG. 16 illustrates date markers according to embodiments of the invention.

FIG. 17 is a flowchart illustrating a method for generating a swimlane timeline diagram according to embodiments of the invention.

FIG. 18 illustrates an example of the swimlane timeline resource view according to the embodiments of the invention.

FIG. 19 is a block diagram of an example embodiment of a computer system upon which embodiments inventive subject matter can execute.

### DESCRIPTION OF THE EMBODIMENTS

In the following detailed description of exemplary embodiments of the inventive subject matter, reference is made to the accompanying drawings which form a part hereof, and in which is shown by way of illustration specific exemplary embodiments in which the inventive subject matter may be practiced. These embodiments are described in sufficient detail to enable those skilled in the art to practice the inventive subject matter, and it is to be understood that other embodiments may be utilized and that logic and other changes may be made without departing from the scope of the inventive subject matter. The following detailed description is, therefore, not to be taken in a limiting sense.

### Overview

Companies struggle to gain insight and control of their task data; particularly when it is associated with a specific project. Companies also have the need to view tasks within one project in relation to tasks of another project, or collection of projects. This is sometimes referred to as a Portfolio view. In addition, companies desire a method to drill-in on tasks for additional detail as necessary. They also seek methods for filtering on a specific date range, and filtering, grouping and sorting tasks to focus their attention on key tasks for analysis and reporting.

It is difficult, costly and time consuming to manually build task and portfolio reports with data that is constantly changing. The complexity of generating reports multiplies exponentially as the number of source files increases. The swimlane timeline addresses these issues by leveraging existing task data storage methods and generating a task mapped visualization that is accurate, timely, and easy to decipher for analysis and reporting.

Many users, and many applications, store task data utilizing a parent/child relationship. A parent task can have many associated sub level child tasks. Additionally, child tasks can have subtasks associated with them, and so on. This parent/child relationship is commonly defined and stored in a hierarchical fashion using the outline notation “n.n.n . . . ” and is referred to as an outline number, or project task work breakdown structure. Each task may also have an associated start date and/or finish date. Tasks can additionally have an associated percent complete value, as well as task dependencies defined, and often a critical task field. The swimlane timeline application systems and methods, according to their various embodiments, can utilize any or all of these task fields for customized task analysis and report generation.

Data may have relationships in addition to parent/child relationships that are defined by common attributes associated with the data. For example, a Microsoft Excel spreadsheet may have rows of data containing many columns or fields that further designate the relationship of the data. A Microsoft Project schedule may have custom task fields, either local or enterprise, that further categorize tasks and define their relationships. Various embodiments of the swimlane timeline application have the capability to group, filter, and sort by those common attribute fields associated with the data.

In some embodiments, the swimlane timeline application is implemented as a Visio add-on template that runs on the Microsoft Office Visio 2003, 2007 and 2010 (Standard or Professional) graphics engine, and it contains Visio object model methods, functions, subroutines, as well as Visio ShapeSheet algorithms, and custom developed Visio Shapes that permit reading the project task data from the source file(s), applying user selected filters and visualization preference settings, and automatically generating a diagram referred to as a swimlane timeline.

The top level timeline of the diagram may be defined by the start and finish date of the user specified top level parent summary task. When multiple source files are selected, embodiments of the swimlane timeline system run through each selected source file's parent task, and determine the earliest start and latest finish dates that encompass all source files selected. Once the top level timeline start and finish dates are established, the timeline is placed at the top of the diagram. The timeline length and time interval determines the diagram width. The lowest level interval is user selectable, and in some embodiments can be either 1 day, 3 Days, 5 Days, Weeks, 2 Weeks, Months, Quarters, Half-Years, Years, or Auto. An “Auto” setting provided in some embodiments allows solution algorithms to determine an interval type best used for the generation of a 3:4 aspect ratio visualization and printing.

The swimlanes can be determined either by the outline number hierarchy, or by a user selected Group-by field that is associated with tasks. By default, the swimlanes are vertically stacked below the timeline in the order that they are encountered in the data from top to bottom. A sort swimlanes by name option allows users to override the default ordering. Other ordering methods are possible and within the scope of the inventive subject matter. When swimlanes are determined by outline number hierarchy, then Milestones at the same outline level as the swimlanes are placed in a special “High Level Milestones” swimlane.

Tasks are displayed within swimlanes grouped hierarchically or by a common use selected group-by attribute. Tasks are, by default, placed in swimlanes using a compressed relational method. The compressed relational method of task placement puts tasks within their associated swimlanes in the order that they are encountered, but this order can be overridden with a user selected sort order applied. The swimlane task placement logic attempts to place a task in the swimlane top sub-row, and if there is no shape or text collision with other tasks within that swimlane, then the task is placed on that swimlane sub-row. If there is a shape or text collision, then an attempt is made to place the task on the next lower swimlane sub-row. If a shape or text collision occurs in every existing swimlane sub-row, then a new swimlane sub-row is added to the swimlane below the bottom existing sub-row, and the task is placed on that new swimlane sub-row. Additionally, for the compressed relational method of task placement, if any parent/child task relationships exist for tasks that are visible within a swimlane, then the child tasks are placed in swimlane sub-rows located vertically beneath their parent.

The swimlane timeline diagram page height and/or width automatically grows to encompass the entire diagram as swimlanes grow.

A further aspect of various embodiments includes the ability to select multiple source files with multiple file types for the creation of an ad hoc cross-project portfolio view. A swimlane is created for each individual source file specified. When multiple source files are specified then it is desirable that each of the source files have a field that can be used to define the outline level hierarchy. That field is typically the task outline number field. However, other fields may be used to define the hierarchy. By default, tasks at outline level 1 are displayed within the swimlanes.

A further aspect of various embodiments includes the ability to filter by a selected field from a pull-down pick list. All project schedule non-empty local and enterprise custom task fields (Text, Flags, and Date) are available to select. Filtering by a task text field will display only tasks with that associated text field having a non-empty value. Filtering by a task flag will display only tasks with the flag set to non-case-sensitive “True” or “Yes”. Filtering by a task date field will display only tasks where the date field selected has a non-default date value.

A further aspect of various embodiments includes the ability to group swimlanes by values within a selected field. The field may be selected from a pull-down pick list. All project schedule non-empty local and enterprise custom task fields (Text, Flags, and Date) are available to select.

A further aspect of various embodiments includes the ability to sort by a selected date field from a pull-down pick list. All custom task date fields in the source data are available to select.

A further aspect of various embodiments includes the ability to select the number of task outline levels deep to display in the swimlane timeline.

A further aspect of various embodiments includes the ability to save, apply, rename and delete formatting styles. When the user selects save style, they enter a name for the style to save, and all formatting style values are saved in an associated XML file. When the user selects apply style, the swimlane timeline is regenerated with the selected formatting style applied. The rename option allows a user to rename an existing style, and the delete option will remove the Style.

A further aspect of various embodiments includes the ability to add a new page that allows the creation of multiple page reports based on the same source data. Each page can be a unique view into the same source data. For example, one page might show a filtered view showing milestones only, another page might have tasks grouped by functional area, and another page might be a resource view showing tasks associated with selected resources.

A further aspect of various embodiments includes the ability to refresh a swimlane timeline with the latest versions of the source data while retaining custom formatting that has been applied to the swimlane timeline.

A further aspect of various embodiments includes the ability to display a resource view that shows the tasks that are assigned to selected resources where each resource gets their own swimlane, and the tasks assigned to a resource are displayed within the swimlane. This view provides a ballpark view into resource over or under allocation, and can be particularly useful when working with multiple source files with a shared resource pool. The vertical height of the task shape within the swimlane indicates the percent the resource is allocated, and the exact percentage can be seen by hovering over the shape.

A further aspect of various embodiments includes the ability to select the viewed timeline date range by either specifying an exact start and end date to filter on with the “Select Date Range” option, or by selecting the start and ending intervals in the timeline itself and then using the right-click “Show Selected Date Range” option.

A further aspect of various embodiments includes the ability to show or hide cross-swimlane date line indicators. By default, the Today's Date Line is shown through all swimlanes as a red line. A user can easily hide the Today's Date Line by selecting the “Hide Today Indicator” option. A user can also add their own custom date lines that span across all swimlanes with the “Add Date Indicator” option. When selected, a blue line is shown running through all swimlanes. The user can click and drag the line to a general timeline position or right-click on the line and specify an exact date. The date lines can be customized using Visio's line formatting commands.

A further aspect of various embodiments includes the ability to create, add, edit, and delete task date markers. Date markers can be visualized either below or above tasks that are displayed within swimlanes. Date markers can be represented with any Visio line end style and color. The date marker text is shown as mm/dd near the date marker. By default the task start date is shown beneath a task.

A further aspect of various embodiments includes the ability to change interval visualization style by selecting from the available pick list items in the interval style option.

A further aspect of various embodiments includes the ability to change task shading style from no shading, percent complete shading or percent progress shading. Default task shading is percent complete.

A further aspect of various embodiments includes the ability to change swimlane compression methodology used. There are three swimlane style options you can choose from: compressed, expanded, and relational. Selecting Expand swimlane will expands the tasks within a swimlanes so there is no layout compression and each task is on its own swimlane row. Selecting Compress swimlane methodology will compress the tasks within a swimlane to fit within as tight an area as possible while minimizing shape and text collisions—regardless of the parent/child relationships of the swimlane tasks. Selecting Relational swimlane method compresses the tasks within a swimlane avoiding shape and text collisions, but, in addition, it will ensure that any child tasks are placed in swimlane rows that are beneath the parent task row. When an option is selected, it is applied to all swimlanes on the page.

A further aspect of various embodiments includes the ability to sort swimlanes by a selected date field from a pull-down pick list. Tasks can be sorted by any date field such as: start date, finish date, actual start date, or baseline finish date.

A further aspect of various embodiments includes the ability to show or hide a fiscal year calendar within the timeline area.

A further aspect of various embodiments includes the ability to change color definitions for any aspect of the swimlane timeline that effect an individual task using Visio's formatting capabilities, or affect an entire page by editing fields in the Visio Shape Data window or affect all pages by editing the color definitions in the program XML configuration file.

A further aspect of various embodiments includes the ability to change the header logo displayed using the Change Title Logo option.

A further aspect of various embodiments includes the ability to highlight critical tasks that have the Microsoft Project “critical” field set to “Yes” by selecting the “Show Critical Task Highlight” option that will highlight tasks in red.

A further aspect of various embodiments includes the ability to show or hide task dependencies by selecting the “Show Dependency Connectors” option. When selected, connectors between dependent tasks are displayed. Tasks are deemed dependent if a task Unique ID Predecessor points to a Unique ID of another task.

A further aspect of various embodiments includes the ability to create, edit, rename, and delete named filters. When defining a new Named Filter, users can Cut, Copy, Paste, Insert and Delete filter-by-value rows. The And/Or, Field Name, Test and Value items in each row will present a pick list of available options when clicking in the field cell. All Named Filters will show up in the Filter-by pick list, and can be identified with the “(Named)” label that has been added.

A further aspect of various embodiments includes the ability to apply pre-defined color palettes. There are a number of pre-defined color palettes that are fixed, and, in addition, there are two color palettes called “Primary” and “Secondary” that are customizable. A company might use the Primary color palette for corporate color settings, and the Secondary color palette for divisional color settings.

A further aspect of various embodiments includes the ability to apply preset short names or nicknames. The task names displayed in a swimlane timeline are the source file names. Sometimes these names can be very long, and the user may not need to have the entire name displayed, and a shorter name or acronym would suffice. There are two methods that a user can use to change the task name shown: either manually or automatically. The user can manually edit the Task “Short Name” field in the Shape Data Window, and because the task name displayed is always fed from the Task Short Name field shown in the Shape Data Window, the new short name is immediately reflected in the Swimlane timeline task name displayed. If the user wants to consistently re-use the same task short names in the Swimlane timeline view of their project schedule, then the user may create a Custom Task Text Field named “VisibilityShortName” in the source data, and use that field to preset the task short names. After the user generates a Swimlane timeline, preset task short names may be applied by using the “Visibility/Formatting/Use Short Names Custom Field” option. When using a Short Name, the user can hover over any task to view the task long name.

A further aspect of various embodiments includes the ability to apply preset task colors. If the user wants to consistently re-use the same task colors in the Swimlane timeline view of their project schedule, then a Custom Task Number Field named “VisibilityColor” may be created in their source data, and used to preset the task colors. After generating a Swimlane timeline, the preset task colors are then applied by using the “Visibility/Formatting/Use Task Color Custom Field” option. Color numbers are mapped according to the Visio's Color Palette available in Visio at “Tools/Color Palette” option.

A further aspect of various embodiments includes the ability to apply preset milestones types. If the user wants to consistently re-use the same task milestone type in the Swimlane timeline view of their project schedule, then the user may create a Custom Task Number Field named “VisibilityType” in their source data, and use that field to preset the task milestone type. After generating a Swimlane timeline, the preset task milestone types may be applied by using the “Visibility/Formatting/Use Milestone Type Custom Field” option. Milestone types include but are not limited to the following shapes: diamond, two triangles, pin, star, and up arrow.

A further aspect of various embodiments includes the ability to paginate to PowerPoint option that breaks up a vertically long Swimlane timeline across multiple pages with each page showing the same Header and Footer, and then it automatically builds a PowerPoint slide deck from the resulting pages.

A further aspect of various embodiments includes the ability to paginate to new drawing that breaks up a vertically long Swimlane timeline across multiple pages with each page showing the same Header and Footer for printing or saving to PDF. The original diagram is still open for making other visual changes. The resultant paginated diagram has the Swimlane timeline options disabled.

A further aspect of various embodiments includes the ability to copy to Windows clipboard so that the swimlane timeline may be easily pasted into other types of documents.

A further aspect of various embodiments includes the ability to send a swimlane timeline page to Microsoft PowerPoint.

A further aspect of various embodiments includes the ability to drill-in for more detail in a swimlane timeline hierarchical view by using the task right-click to “drill-in”. A drill-in creates a new Visio page with the selected task as the new page title, and showing its subtasks as swimlanes, and their child tasks as tasks within the swimlanes. The new page includes bi-directional HOME and UP icons that support Visio double-clicks as well as hyperlinks. The page hyperlinks are preserved when shared as PDF or Web Pages to allow users to have interactive navigation while viewing outside of Visio.

A further aspect of various embodiments includes the ability to create new page from selected swimlanes by shift-selecting the desired swimlanes then using right-click and selecting Create New Page.

A further aspect of various embodiments includes the ability to hyperlink to a selected project task by using right-click on any swimlane task, and then selecting the Project Task hyperlink.

A further aspect of various embodiments includes the support of, but not limited to, the following source file formats:

Project 2000-2010 MPP files

Excel 97-2010 XLS files

Project Server 2003-2010 files

SharePoint 2003-2010 Task Lists

And other software platforms and file formats.

A further aspect of various embodiments includes the option to reposition the task label with a right-click action on the task. Possible task label positions for intervals include: Wrapped Centered, Wrapped Right, and Wrapped Left. Possible label positions for milestones includes all of the above, and in addition: Centered, Upper Right, Upper Left, Centered Right, Centered Left, Lower Right and Lower Left. Alternatively, users can freely reposition the task label using Visio's native Text Block Tool.

A further aspect of various embodiments includes the full support of Visio native features including, but not limited to: color control, text control, line types, fill types, print controls, save as web, pan and zoom window, keyboard shortcuts, layer control, and selecting multiple shapes and changing settings for all.

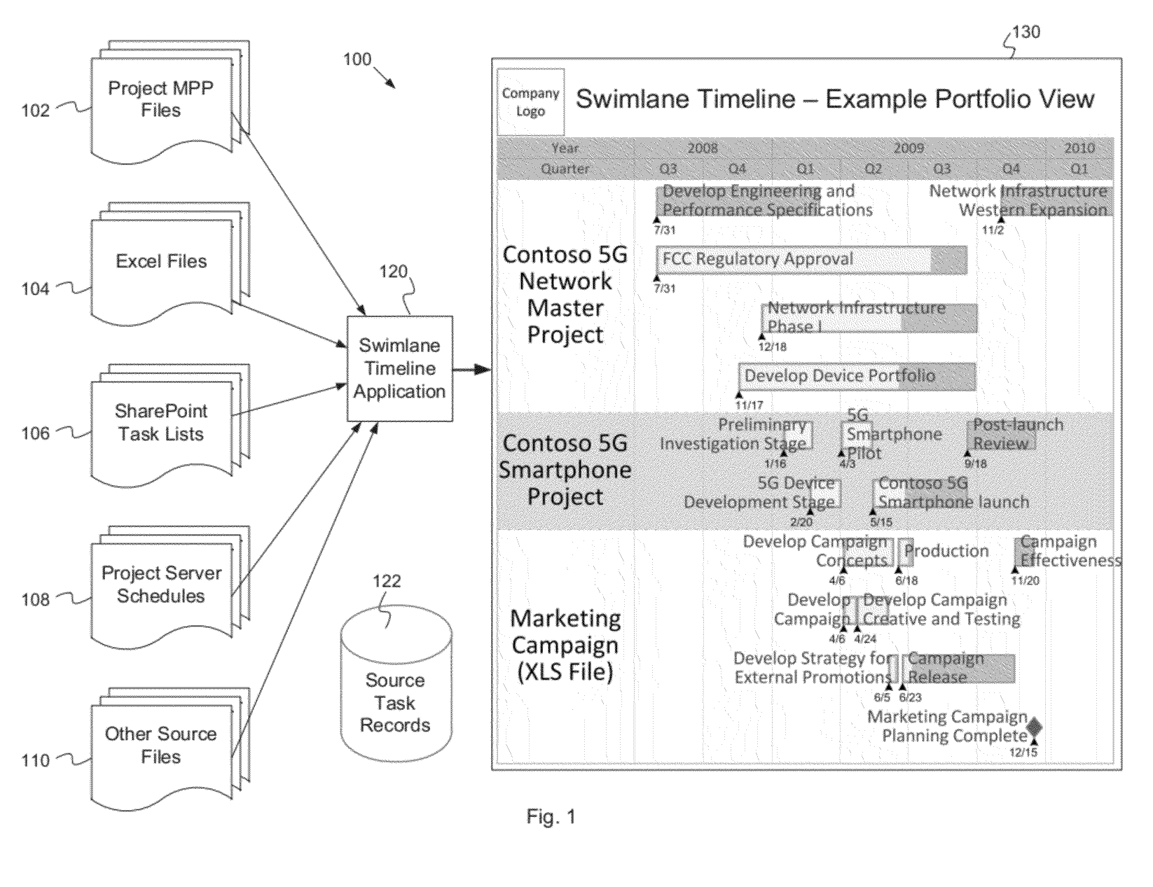

FIG. 1 is a block diagram illustrating the components of a swimlane timeline system 100, an example Process Flow with Task Data Records input, and a swimlane timeline visualization output. In the example system 100, workflow includes software swimlane timeline application 120. In some embodiments of the inventive subject matter, the swimlane timeline application 120 may be implemented using C# programming language and the .NET Framework 2.0 development environment available from Microsoft Corporation. However, the embodiments of the inventive subject matter are not limited to a particular programming language or development environment. In alternative embodiments, the software application may, for example, be developed using Visual Basic, C++ or Visual Basic for Applications programming languages. Swimlane timeline application 120 may interface with diagramming software or software components. In some embodiments, the swimlane timeline application 120 interfaces with a Microsoft Visio drawing engine that provides programmatic access to the Visio object model and Visio ShapeSheet environment. In alternative embodiments, other diagramming software components may be used. Examples include Schematic, SmartDraw, Dia, OmniGraffle, Inspiration, JGraph or ConceptDraw 7. The embodiments are not limited to any particular diagramming software component.

Various source files may be used to provide data for the swimlane timeline application 120. Examples of such source files include one or more of the following:

Microsoft Project MPP files 102

Microsoft Excel XLS files 104

Microsoft SharePoint Task Lists 106

Microsoft Project Server project schedules 108

Other source files that contain similar fields 110

FIG. 1 also illustrates various source file task fields 122 that may be used, and optional fields for the swimlane timeline application 120. The source file task fields that are used in some embodiments include:

Task Name (text)

Task Outline Number (text)

Task Starting Date (date)

Task Finish Date (date)

The source file task fields that are optional in some embodiments include:

Percent Complete (number)

Critical″ (Yes/No Flag)

Unique ID (text)

Unique ID Predecessors (text)

Baseline Start (date)

Baseline Finish (date)

Actual Start (date)

Actual Finish (date)

Visibility (Yes/No flag)

Visibility Color (number)

Visibility Type (number)

Visibility Short Name (text)

Milestone (Yes/No flag)

Resource Names (text)

VisibilityShortName (text)

VisibilityColor (number)

VisibilityType (number)

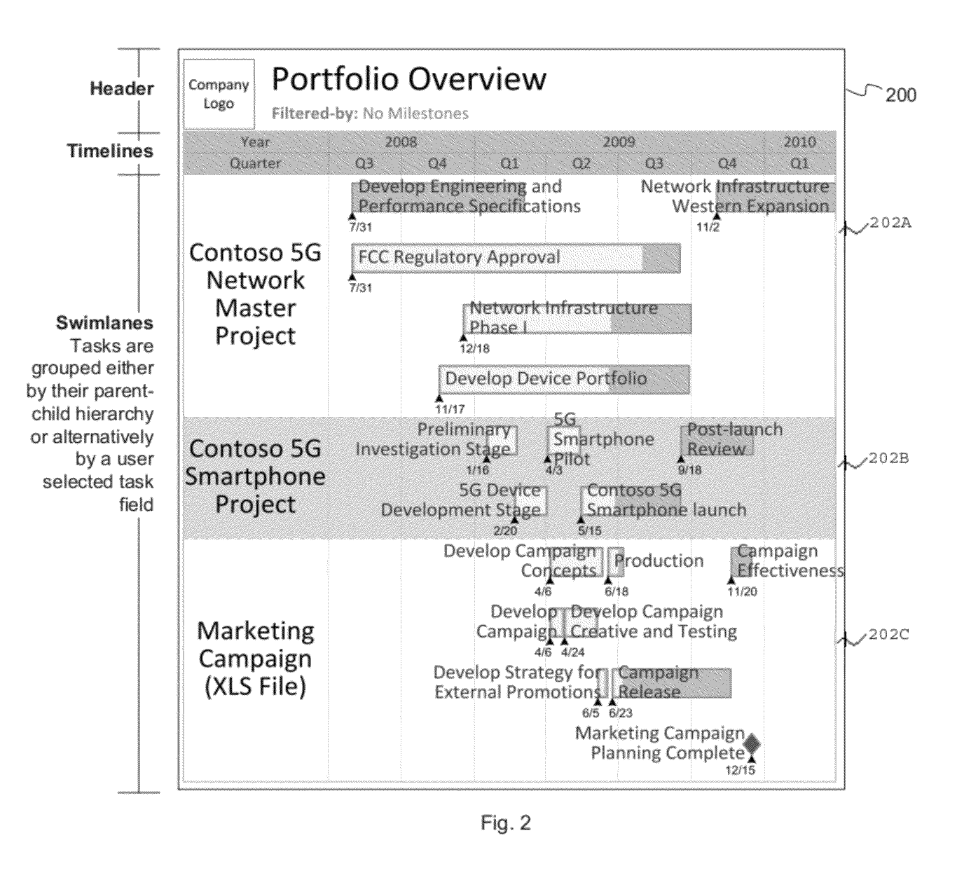

FIG. 2 illustrates an example swimlane timeline 200 according to embodiments of the invention. Swimlane Timeline 200 shows an example Parent/Child/Grandchild Task (n.n.n . . . ) Visual Mapping for swimlanes 202. By default, the top level parent task, summary task outline number 0, is the Header title, and its child tasks are at outline number “n” and are the swimlanes. The grandchild tasks are at outline number “n.n” and are shown as tasks within the swimlanes. Therefore, by default the 3 levels of visualization depth is the summary task 0, its “n” children, and their “n” children, or “0.n.n”. The summary task 0 defines the diagram title and timeline date range. Child tasks 1-n define the swimlanes. If a child task has duration of 0 where the start date equals the finish date, then it is interpreted as a high level milestone, and is placed in a special High Level Milestones swimlane. The subtasks of the Child tasks 1-n are placed within their associated swimlanes 202 as intervals or milestones.

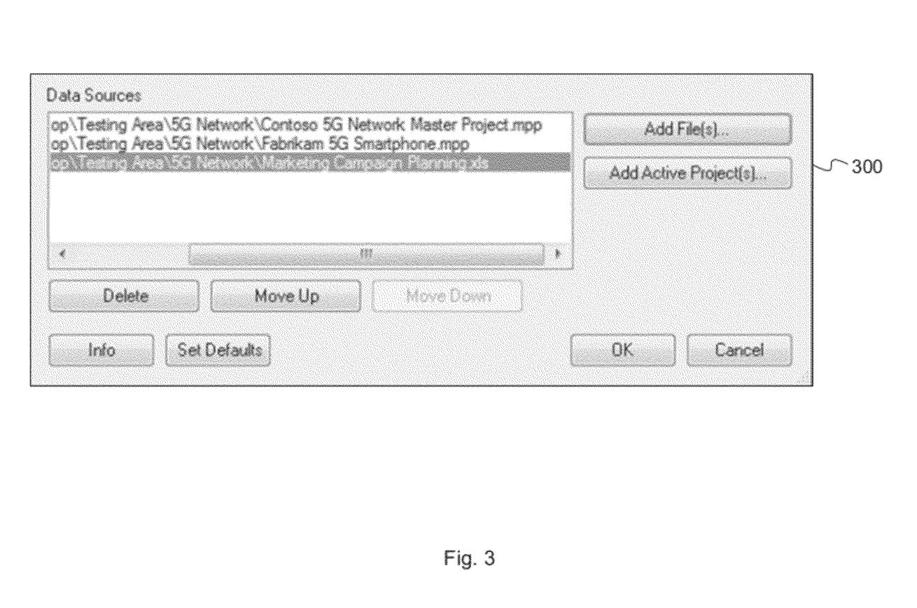

FIG. 3 illustrates an example source file selection dialogue 300 used in embodiments of the invention. Dialogue 300 may be presented when the swimlane timeline application 120 is first opened. The dialogue can also be accessed after the initial diagram is generated, with a right-click action on the Swimlane Timeline white border area, or from the Visibility pull-down menu. This will permit diagram regeneration. If the source files remain constant, then the regeneration process will reference cached task data, and, therefore, the swimlane timeline will regenerate immediately. If the source files are changed in the dialogue, or if a swimlane timeline diagram is re-opened, then the source files will be re-read to ensure that the latest source data is utilized. A saved portfolio view of multiple source files, therefore, can be quickly regenerated with the latest task data by selecting the Refresh option.

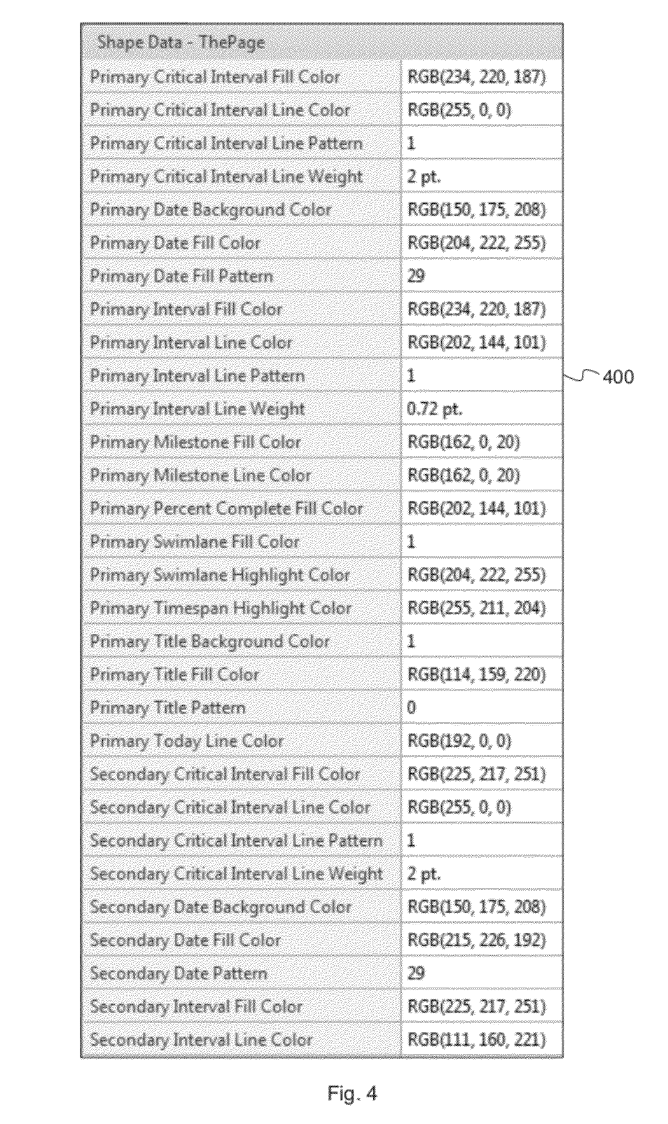

FIG. 4 illustrates an example primary and secondary color palette configuration dialogue 400 used in embodiments of the invention. This ability to see and change color definitions is accessed from the Visibility pull-down menu, and color palette values can be modified with either the Visio 2003 Custom Property Window, or the Visio 2007 or Visio 2010 Shape Data Window.

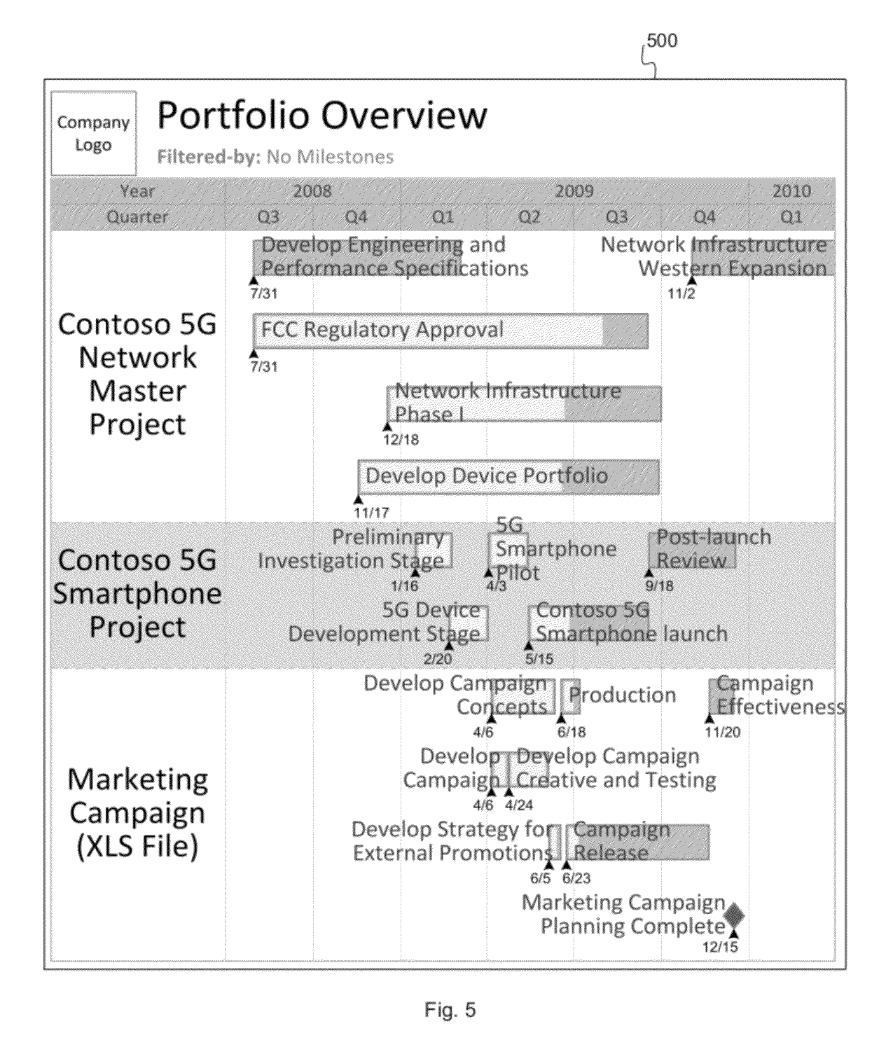

FIG. 5 illustrates an example portfolio view 500 according to embodiments of the invention. In the example provided, the Portfolio View 500 includes the display of a percent complete for tasks in the view. If a “Percent Complete” field exists in the source data, then the percent complete value is interpreted graphically on the task that it is associated with. It usually starts from the interval task left side, and the length of the graphic displayed is determined as a percentage of the overall length of the interval task. The percent complete shapes are placed on a Visio “Percent Complete” layer so they can be easily shown or hidden.

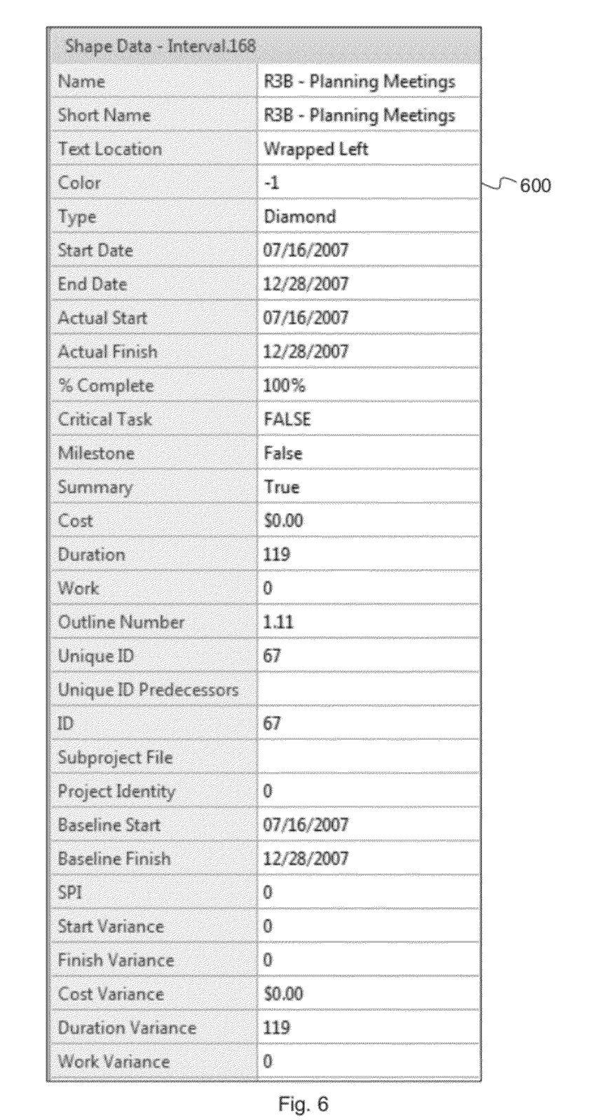

FIG. 6 illustrates an example task shape data 600 according to embodiments of the invention. The example illustrates some of the fields that can be read from the source data for each task, and are associated with each task within the swimlane timeline.

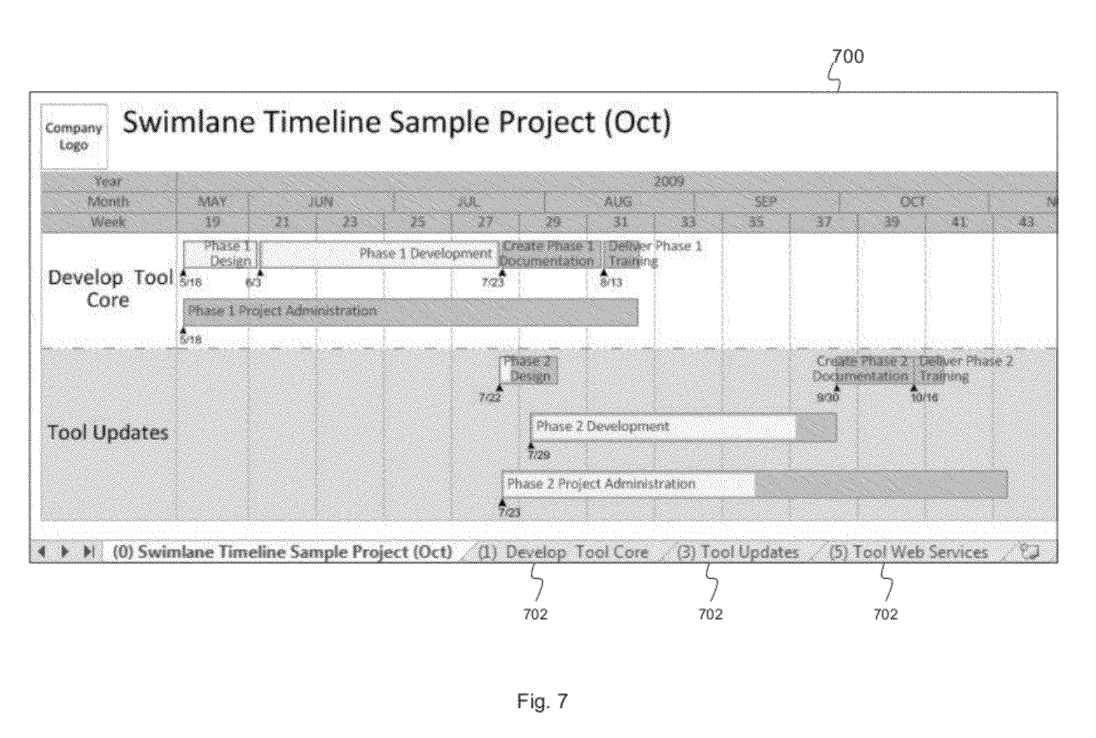

FIG. 7 illustrates an example multi page outline 700 according to embodiments of the invention. In the example shown, the Create Drill-in Pages option was used with an auto drill-in depth of 1. A drill-in depth value of 1 creates separate drill-in pages for all swimlanes. A value of 2 will create separate drill-in pages for all swimlanes and all their child tasks.

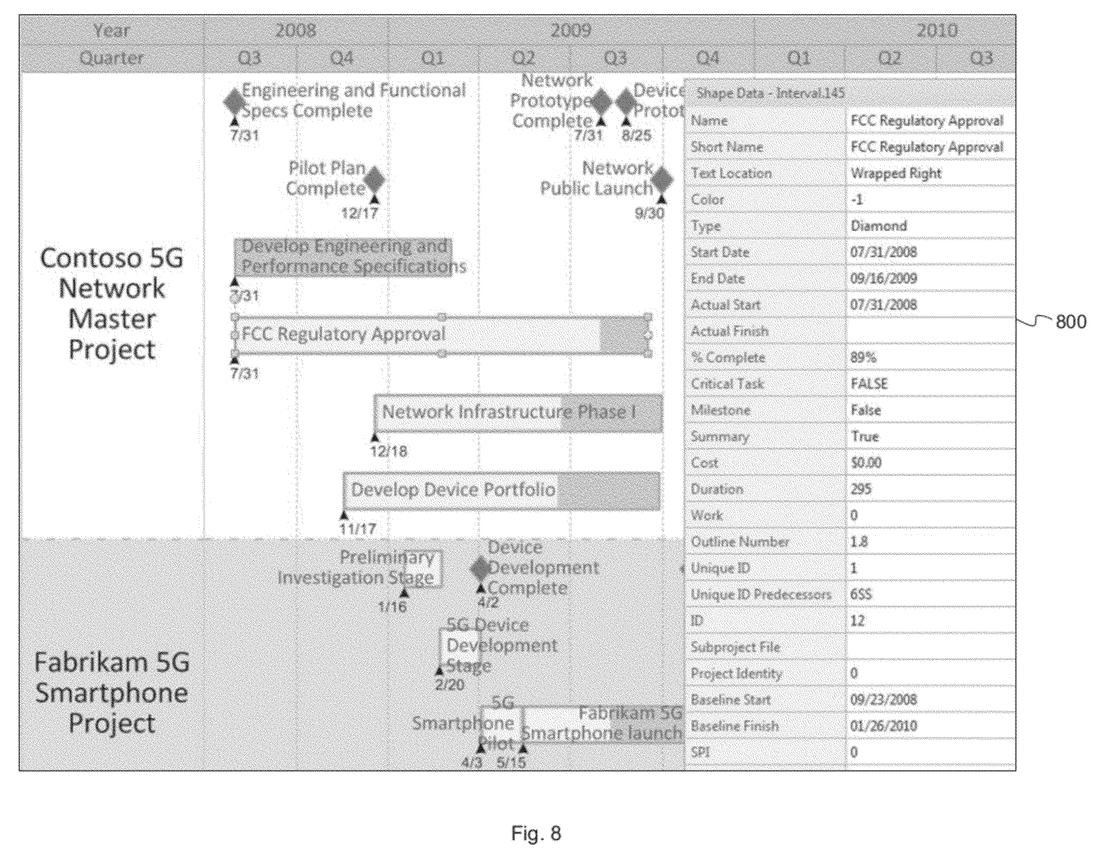

FIG. 8 illustrates an example portfolio view showing percent complete visualization and task shape data properties according to embodiments of the invention. The swimlane timeline application 120 runs through each selected source file's summary task, and determines the earliest start and latest finish dates that encompass all source files selected. Those dates are then used as the date range for the portfolio top level timeline for the source files selected. Each source file is allocated its own swimlane, and each swimlane is placed in vertical alignment from top to bottom one beneath the other in the order in which the source files were selected.

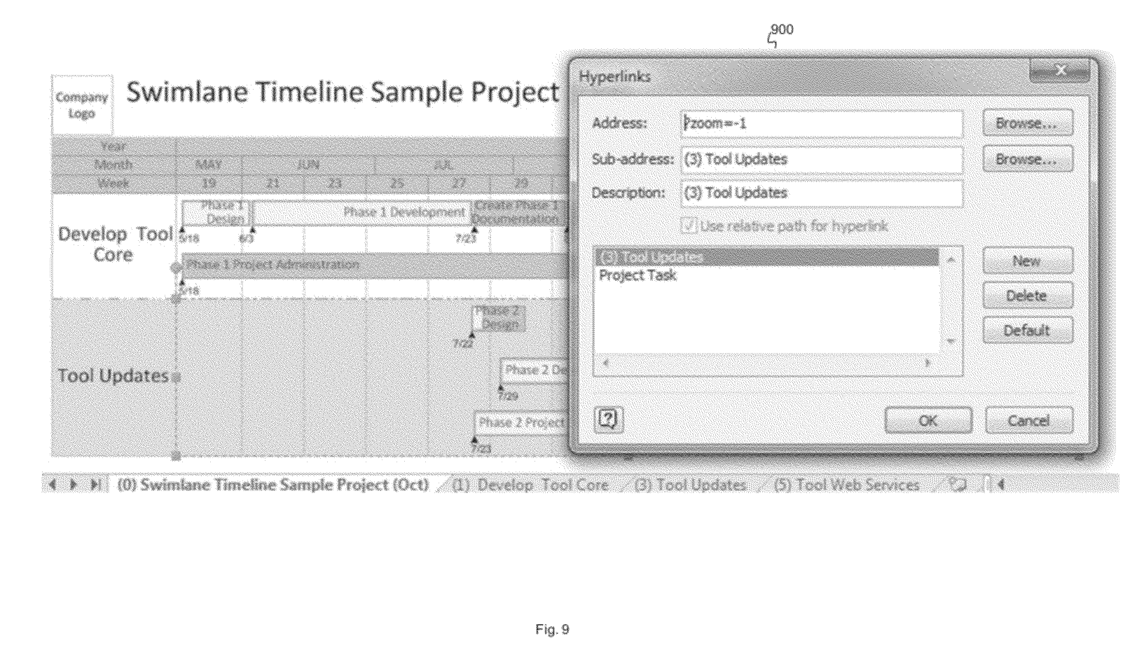

FIG. 9 illustrates an example bi-directional hyperlink created with drill-in 900 according to embodiments of the invention. The drill-in option creates a bi-directional hyperlink, and adds a Visio double-click action, to the selected drill-in object, and its newly built page. This provides an easy navigation method both within Visio, and in alternative formats, such as when the resulting swimlane generated by the swimlane timeline application 120 is saved as an Adobe PDF format, or as HTML pages.

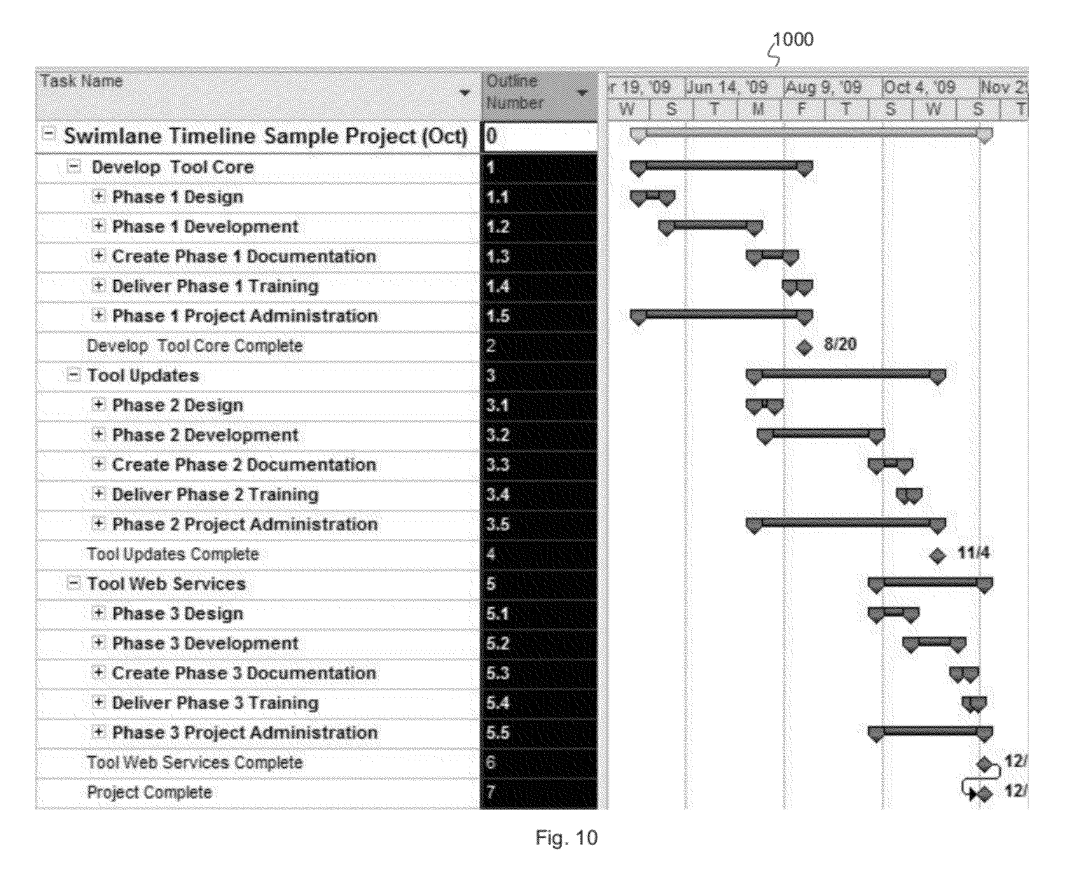

FIG. 10 illustrates an example Microsoft Office Project source file highlighting outline numbers 1000 according to embodiments of the invention. The swimlane timeline application 120 supports Microsoft Project 2000-2003, Microsoft Project 2007, and Microsoft Project 2010 MPP file formats. The outline numbers may be used to define the swimlane timeline task hierarchy.

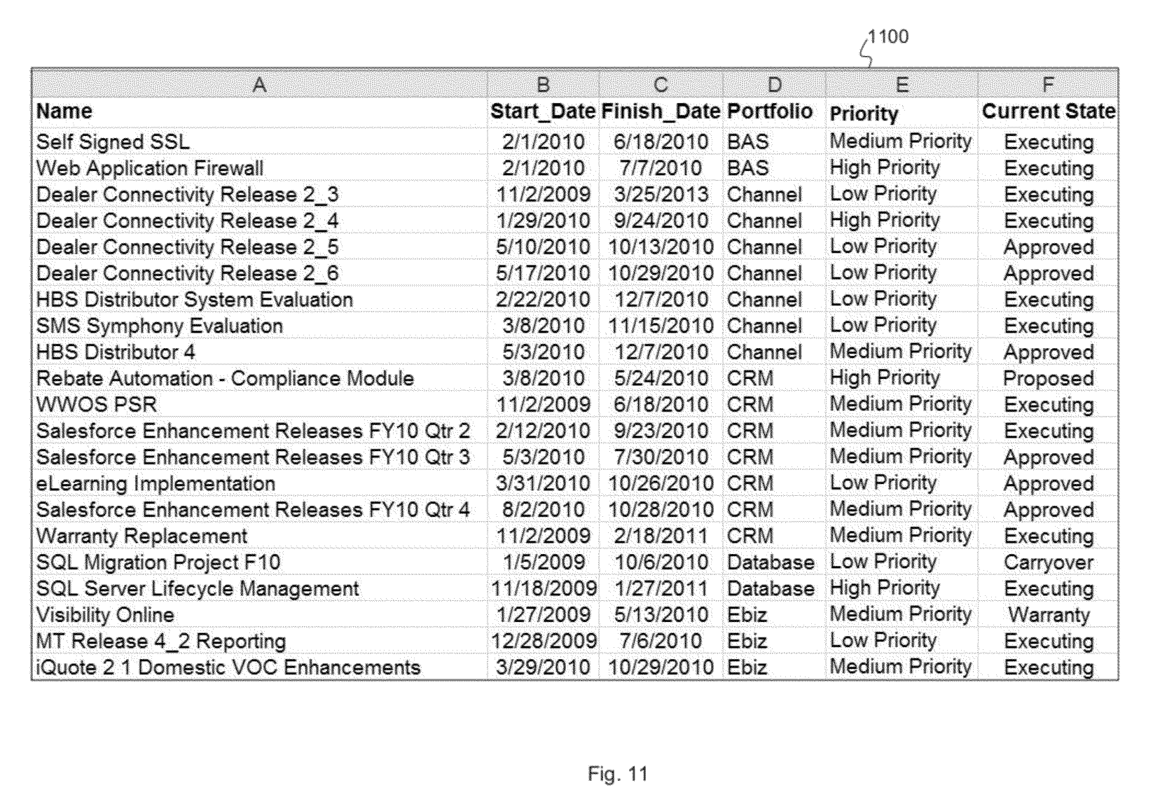

FIG. 11 illustrates an example Microsoft Office Excel source file 1100 according to embodiments of the invention. Various embodiments of the invention support Microsoft Excel 97-2003, and Microsoft Excel 2007, Microsoft Excel 2010 XLS and XLSX file formats. All fields are read by the Swimlane timeline and tasks may be grouped into swimlanes determined by the group-by field selected. In the example illustrated in FIG. 11, source data “Name” items with duration date fields can be displayed and grouped within swimlanes based on additional fields associated with the “Name” items. For example, in FIG. 11 the “Name” items can be grouped by: Portfolio, Priority, and Current State.

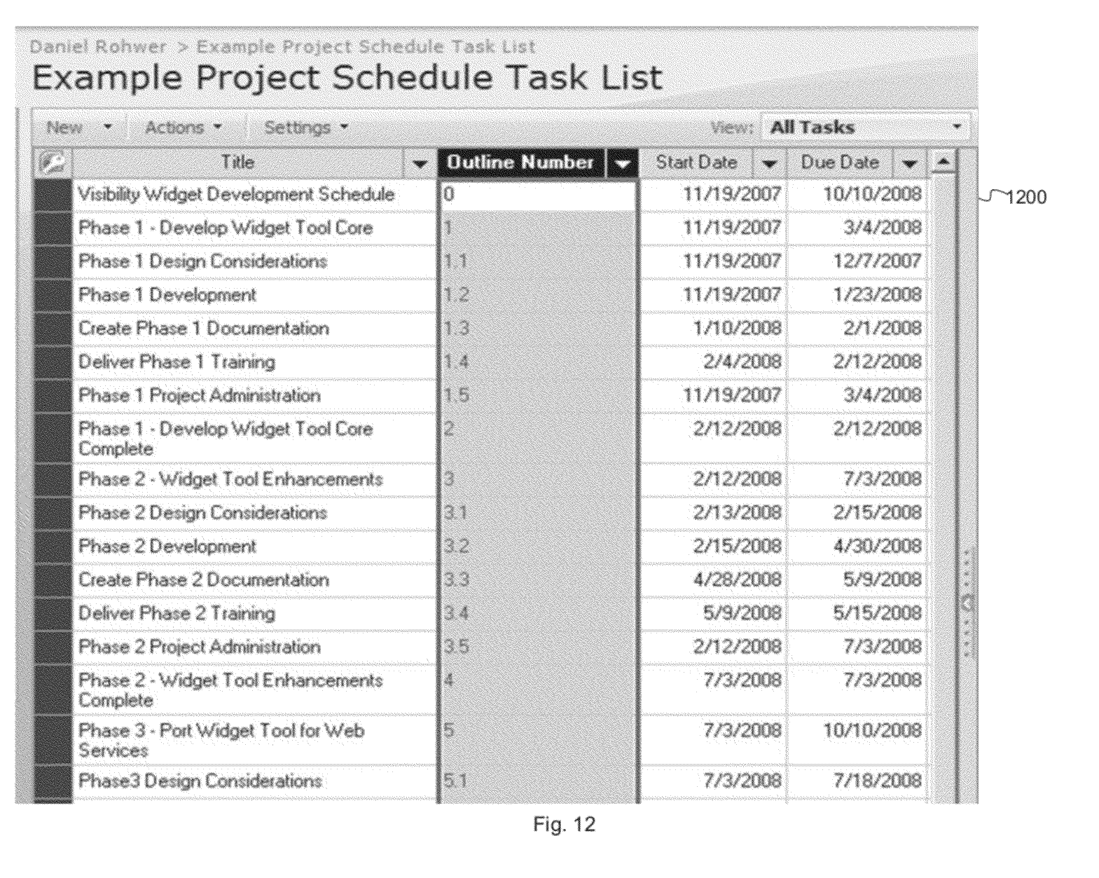

FIG. 12 illustrates an example Microsoft Office SharePoint source tasks highlighting outline numbers 1200 according to embodiments of the invention. Various embodiments of the invention support Microsoft SharePoint 2003, 2007 and 2010 Task Lists. All fields in a SharePoint view are read and tasks may be grouped within swimlanes by outline numbers or by user selected fields. For example, fields associated with each task can be used to group tasks in swimlanes in according to embodiments of the invention.

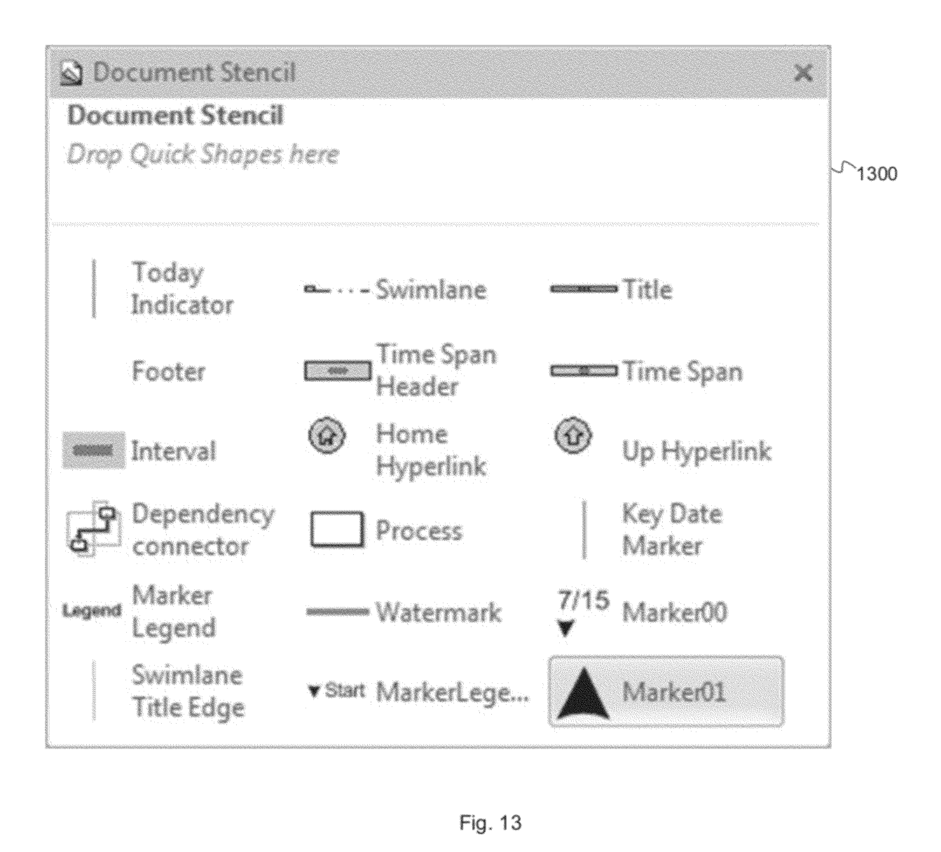

FIG. 13 illustrates an example 1300 of the shapes used in a swimlane timeline and alternate view according to embodiments of the invention. The shapes used to create the swimlane timeline may be custom shapes or shapes that are provided as default shapes with Visio or other software. The shapes can be seen in a Visio Document Stencil that may be part of documents generated by the swimlane timeline application 120. Example shapes in a document stencil are illustrated. The swimlane timeline local document stencil may include, for example: a Date Indicator, a Swimlane, a Title, a Time Span Header, a Time Span, an Interval (this intelligent shape can change geometry from rectangle to diamond, star, pin, double-triangle, and uparrow based on evaluation of the source data), a Footer, a Key Date Marker, and other shapes.

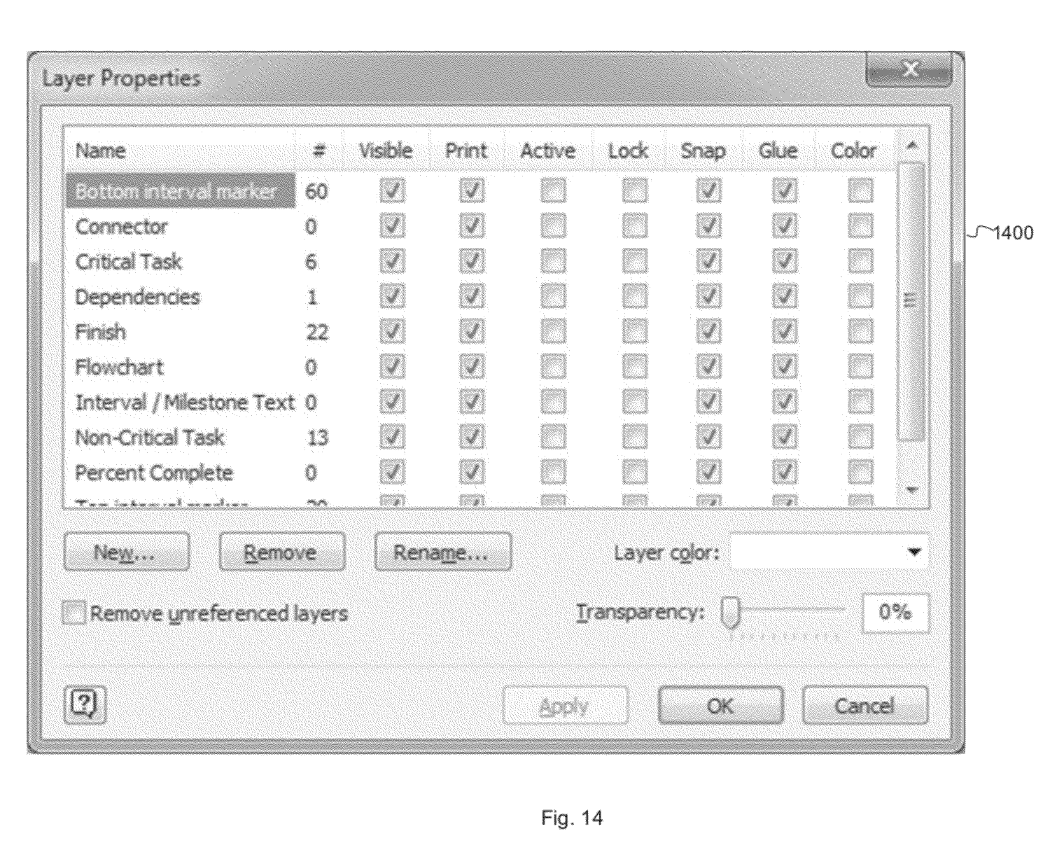

FIG. 14 illustrates an example layer property control and selection 1400 according to embodiments of the invention. The layers are generated by the swimlane timeline application 120, and then displayed in a diagramming software application. For example, in Visio, users may turn off all layers and then only show specific ones, like “Critical Task”, or, if desired, the user could turn just the Interval/Milestone text layer off. Additional layers may also exist for Baseline, Baseline10, Finish, and other characteristics or details.

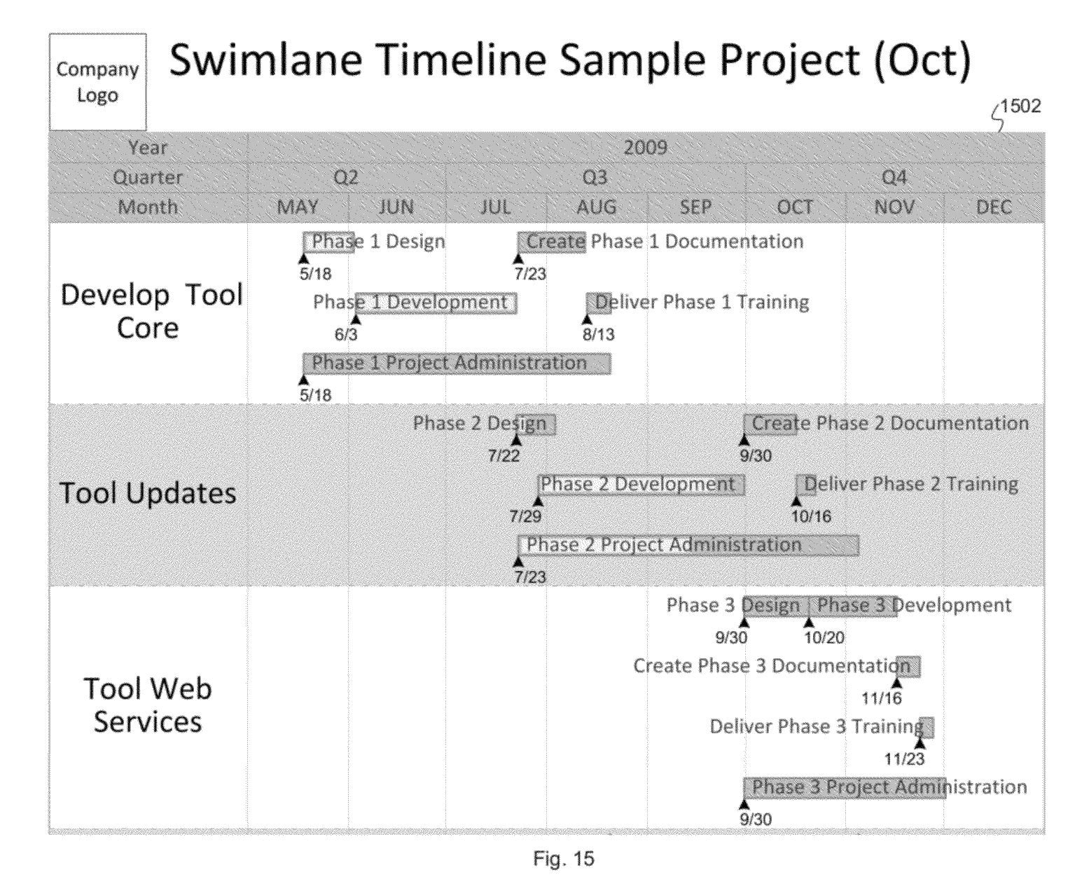

FIG. 15 illustrates a thin interval style for a swimlane timeline diagram according to embodiments of the invention. Some embodiments allow a user to switch interval visualization styles from “Thick Intervals” (default) to “Thin Intervals”. Customized interval styles may also be defined.

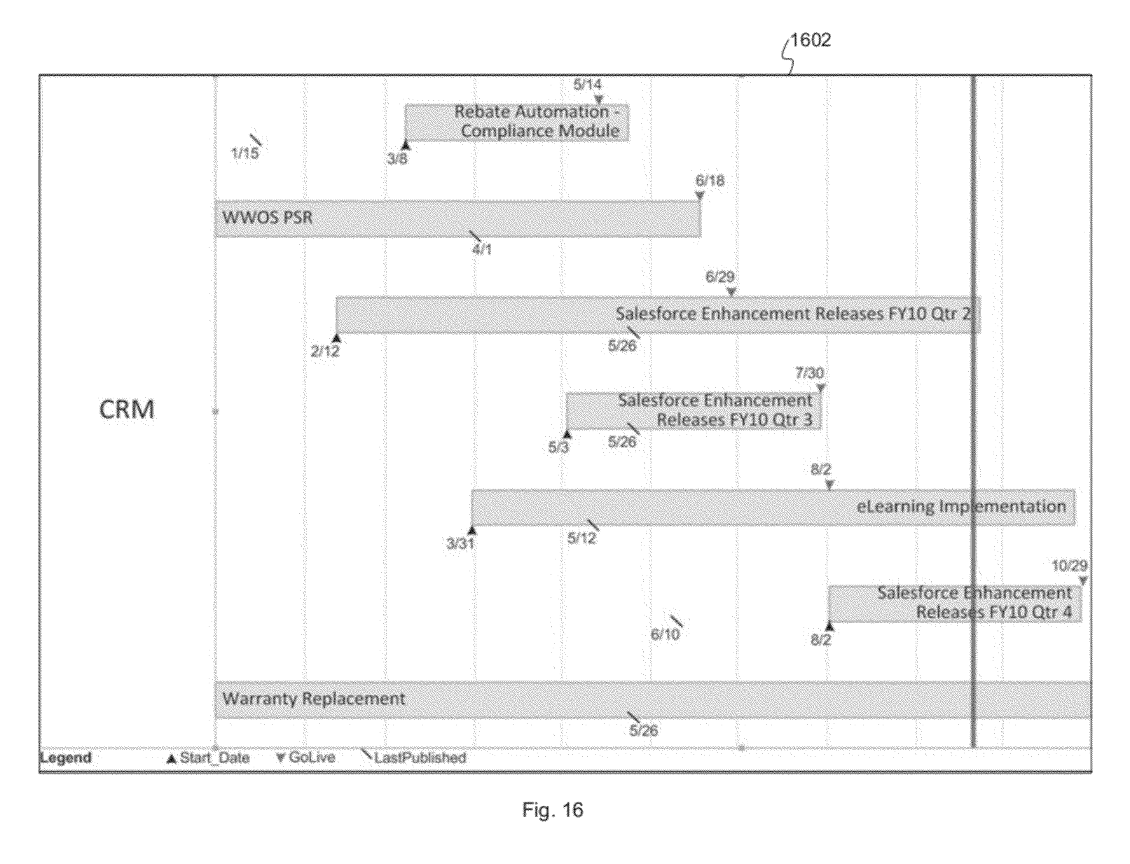

FIG. 16 illustrates Date Markers according to embodiments of the invention. In some embodiments, there are Date Markers for task Start Dates and Finish Dates. An example of Date Markers for Start Date, GoLive Date, and LastPublished Date is illustrated in FIG. 16.

In addition to the examples provided above, various embodiments provide a shading style to be applied based on a percentage complete of a task. In some embodiments there are two Shading Styles to choose from: Percent Complete and Percent Progress (default). The percent complete shading style uses the MS Project % Complete value directly to determine what percent of the interval to shade. The percent progress uses the following formula to determine the percent shading:

Percent Progress=[min(today's date, finish)−start]/(finish−start)*SPI where SPI is the “Schedule Performance Index” showing the ratio of the budgeted cost of work performed (BCWP) to the budgeted cost of work scheduled (BCWS) or (BCWP/BCWS).

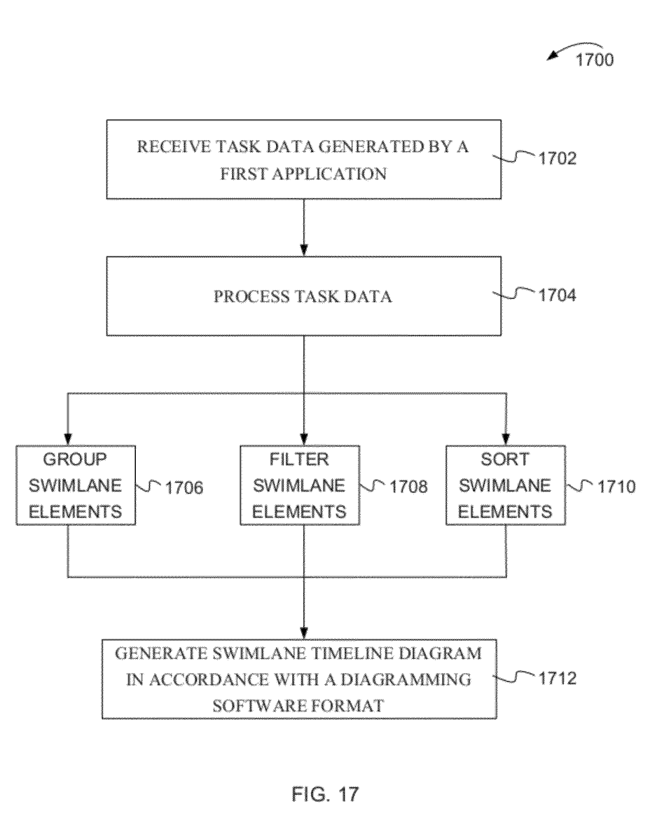

FIG. 17 illustrates a method 1700 for generating a swimlane timeline diagram according to embodiments of the invention. The method begins at block 1702 by receiving task data. The task data may be received from a file, or over a network connection. In some embodiments, the task data may be in a file generated by a project management application such as Microsoft Project. Additionally, the task data may be read from a spreadsheet file such as Microsoft Excel. Further, the task data may be read from a SharePoint formatted file.

At block 1704, a system implementing the method processes the task data. In some embodiments, the task data is processed according to user preferences and display settings. In some embodiments, the placement and layout of tasks for the generation of the swimlane timeline diagram based on the task outline numbers, or alternatively, a user specified task field. The text field values for task outlines may be represented as “n.n.n . . . ” values. A value of “0” indicates the top level summary task. A value of “1-n” represents the sublevel child tasks of the summary task. A value of “n.1-n” represents the lower level grandchild tasks of the summary task and it also represents the children of the sublevel tasks.

If a single source file received at block 1702, then the task outline numbers, are interpreted in the following manner:
a. The user specified starting outline number “n” becomes the top level summary task for the swimlane timeline, and its name is the swimlane timeline title. Its start and finish dates are the timeline start and finish dates.
b. The “n.n” interval tasks become the swimlanes. The “n.n” milestone tasks are placed in a special “High Level Milestones” swimlane. Milestones are defined as tasks with zero duration where the start date and start time is equal to the finish date and finish time.
c. The “n.n.n . . . ” tasks become the intervals & milestones displayed in the swimlanes.

If multiple source files are received at block 1702, then the task outline numbers are interpreted in the following manner:
a. The swimlane timeline is given a default title of “Portfolio View”. The title can later be changed by the user with the Visio text tool.
b. The user specified starting outline number “n” for each source file is evaluated to determine the earliest start date and latest finish date to encompass all tasks. These dates are then used as the start and finish dates for the Portfolio View timeline start and finish dates.
c. The user specified starting outline number task name for each source file becomes each swimlane title.
d. Each source file's associated “n.n” interval and milestone tasks are placed within their respective swimlane.

User custom preferences for the swimlane timeline visualization is supported via source file(s) custom task fields in some embodiments:
a. “VisibilityShortName” text
b. “VisibilityColor” number
c. “VisibilityType” number

User preferences are preserved in an XML configuration file stored in the Microsoft Windows user “Application Data” “Visibility.biz” sub-directory. User preferences are restored with subsequent openings of the source file selection dialogue. Stored preferences may include:
a. Last subdirectory used for source file(s)
b. Checkbox setting to apply source file custom task fields
c. Checkbox setting to show “critical” tasks
d. User defined formatting styles
e. User defined named filters

In some embodiments, various combinations of the following additional user preferences may be supported by the swimlane timeline application 120:
a. Filter tasks based on any task field read in from the source data
b. Group tasks within swimlanes based on any task field read in from the source data
c. Sort tasks by date fields
d. Display task percent complete
e. Display task dependencies
f. Display critical tasks
g. Display today's date line
h. Display fiscal year calendar
i. Filter timeline date range
j. Customize and select text size and color palette

Blocks 1706-1710 indicate operations that may be applied to the task data. Any or all of blocks 1706-1710 may be applied.

At block 1706, the task data may be grouped. In some embodiments, swimlanes may be grouped according to values within a selected field. The selected field may be referred to as a group-by field, while the values in the group-by field may be referred to as group-by values. The field may be selected from a pull-down pick list. All project schedule non-empty local and enterprise custom task fields (Text, Flags, and Date) are available to select.

At block 1708, the task data may be filtered. In some embodiments, fields to be used to filter the tasks appearing in a swimlane may be selected from a pull-down pick list. The fields used to filter task data may be referred to as filter-by fields. The values of the selected fields may be referred to as filter-by values. All project schedule non-empty local and enterprise custom task fields (Text, Flags, and Date) are available to select. Filtering by a task text field will display only tasks with that associated text field having a non-empty value. Filtering by a task flag will display only tasks with the flag set to non-case-sensitive “True” or “Yes”. Filtering by a task date field will display only tasks where the date field selected has a non-default date value.

At block 1710 the task data may be sorted. In some embodiments, swimlanes may be sorted by a selected field. In some embodiments, the field is a date field. Examples of such date fields include Tstart date, finish date, actual start date, or baseline finish date. The field may be selected from a pull-down pick list. The selected field may be referred to as a sort-by field. The values in the selected field may be referred to as sort-by values. All custom task date fields in the source data are available to select.

At block 1712, a swimlane timeline diagram is output according to the processed task data, any filtering, grouping or sorting as described above, and further according to a diagramming software format. In some embodiments, a Microsoft Visio format may be used.

User selected task drill-in on a single task creates a new Visio page in the same Visio VSD file. The new page name is the user selected task name preceded with the task outline number in parenthesis. The swimlane timeline application uses the selected task outline number as the starting outline number for the new swimlane timeline generated, and the diagram will be visualized and interpreted described above.

Auto drill-in of multiple swimlane tasks is a user preference. When selected, separate swimlane timeline pages will be generated as described above. The drill-in process is repeated for the number of levels specified.

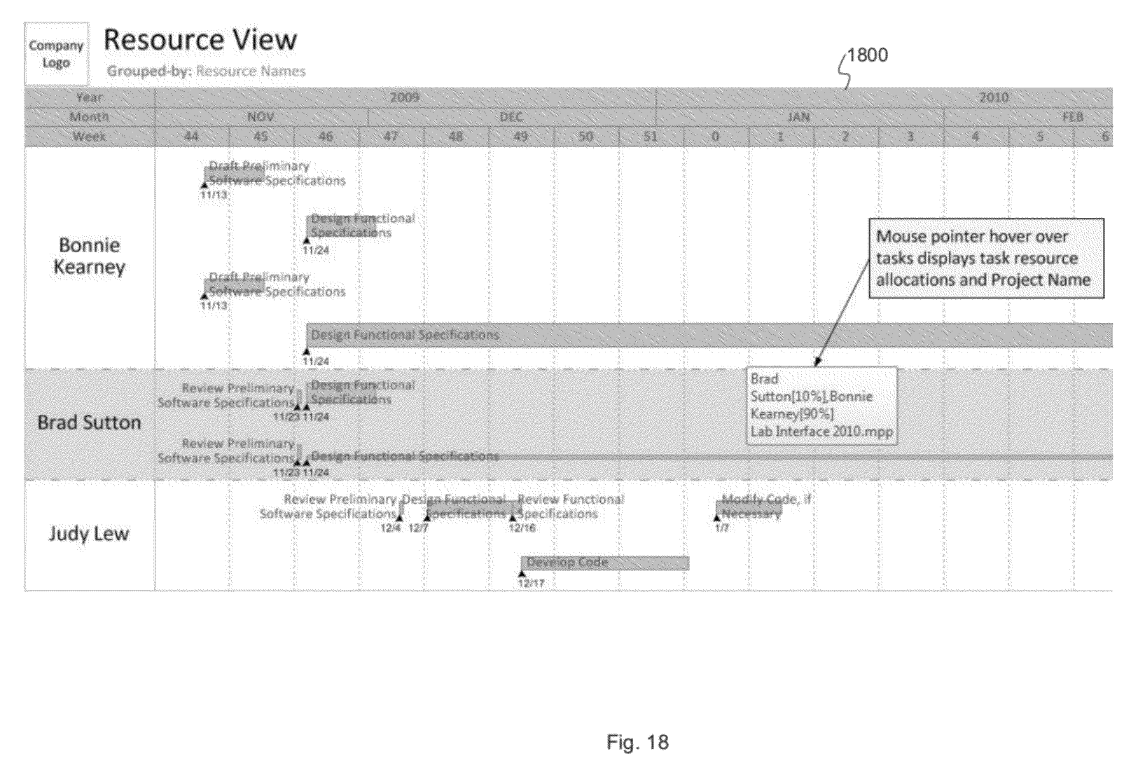

FIG. 18 illustrates an example swimlane timeline resource view according to embodiments of the invention. The swimlanes are grouped by resource. Each resource assigned to a task is given their own swimlane, and the tasks that have been assigned to each resource are displayed within their swimlane. The height of the task displayed represents the percent that the resource has been allocated to the task. Hovering the mouse pointer over a task will display a window showing all resources assigned to the task, the resource allocation percentages, and the source file name that contains the task.

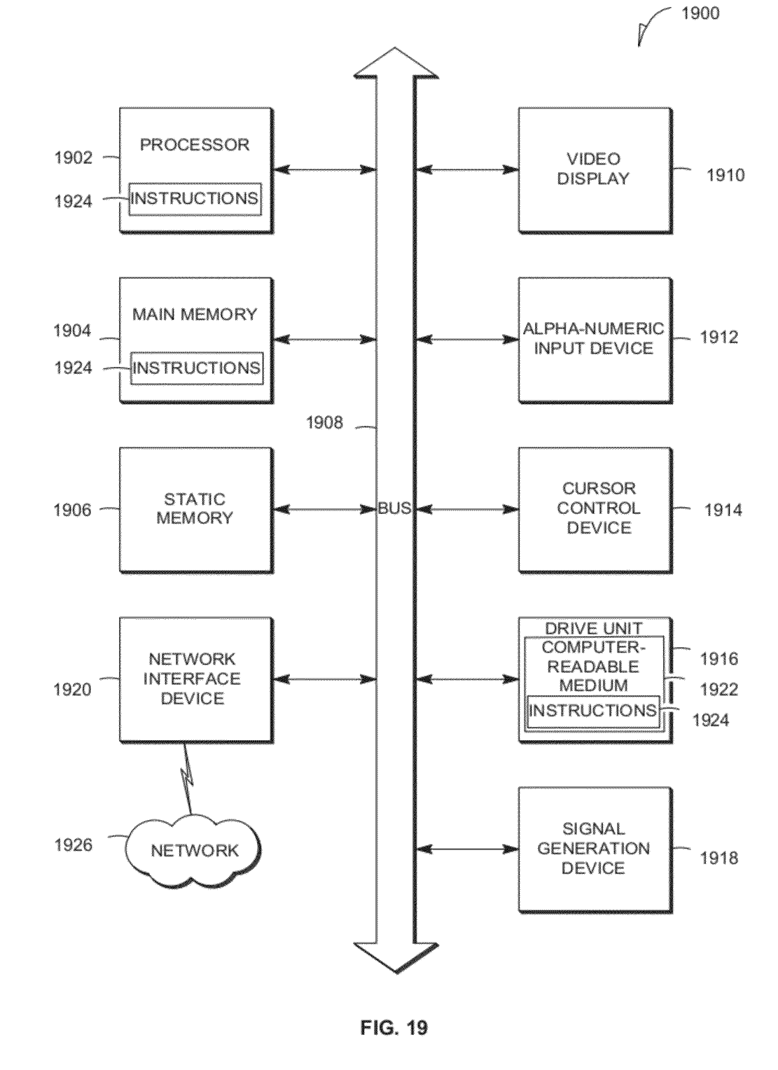

FIG. 19 is a block diagram of an example embodiment of a computer system 1900 upon which embodiments inventive subject matter can execute. The description of FIG. 19 is intended to provide a brief, general description of suitable computer hardware and a suitable computing environment in conjunction with which the invention may be implemented. In some embodiments, the invention is described in the general context of computer-executable instructions, such as program modules, being executed by a computer. Generally, program modules include routines, programs, objects, components, data structures, etc., that perform particular tasks or implement particular abstract data types.

As noted above, the system as disclosed herein can be spread across many physical hosts. Therefore, many systems and sub-systems of FIG. 19 can be involved in implementing the inventive subject matter disclosed herein.

Moreover, those skilled in the art will appreciate that the invention may be practiced with other computer system configurations, including hand-held devices, multiprocessor systems, microprocessor-based or programmable consumer electronics, network PCS, minicomputers, mainframe computers, and the like. The invention may also be practiced in distributed computer environments where tasks are performed by I/0 remote processing devices that are linked through a communications network. In a distributed computing environment, program modules may be located in both local and remote memory storage devices.

In the embodiment shown in FIG. 19, a hardware and operating environment is provided that is applicable to both servers and/or remote clients.

With reference to FIG. 19, an example embodiment extends to a machine in the example form of a computer system 1900 within which instructions for causing the machine to perform any one or more of the methodologies discussed herein may be executed. In alternative example embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. Further, while only a single machine is illustrated, the term “machine” shall also be taken to include any collection of machines that individually or jointly execute a set (or multiple sets) of instructions to perform any one or more of the methodologies discussed herein.

The example computer system 1900 may include a processor 1902 (e.g., a central processing unit (CPU), a graphics processing unit (GPU) or both), a main memory 1904 and a static memory 1906, which communicate with each other via a bus 1908. The computer system 1900 may further include a video display unit 1910 (e.g., a liquid crystal display (LCD) or a cathode ray tube (CRT)). In example embodiments, the computer system 1900 also includes one or more of an alpha-numeric input device 1912 (e.g., a keyboard), a user interface (UI) navigation device or cursor control device 1914 (e.g., a mouse), a disk drive unit 1916, a signal generation device 1918 (e.g., a speaker), and a network interface device 1920.

The disk drive unit 1916 includes a machine-readable medium 1922 on which is stored one or more sets of instructions 1924 and data structures (e.g., software instructions) embodying or used by any one or more of the methodologies or functions described herein. The instructions 1924 may also reside, completely or at least partially, within the main memory 1904 or within the processor 1902 during execution thereof by the computer system 1900, the main memory 1904 and the processor 1902 also constituting machine-readable media.

While the machine-readable medium 1922 is shown in an example embodiment to be a single medium, the term “machine-readable medium” may include a single medium or multiple media (e.g., a centralized or distributed database, or associated caches and servers) that store the one or more instructions. The term “machine-readable medium” shall also be taken to include any tangible medium that is capable of storing, encoding, or carrying instructions for execution by the machine and that cause the machine to perform any one or more of the methodologies of embodiments of the present invention, or that is capable of storing, encoding, or carrying data structures used by or associated with such instructions. The term “machine-readable medium” shall accordingly be taken to include, but not be limited to, solid-state memories and optical and magnetic media that can store information in a non-transitory manner, i.e., media that is able to store information for a period of time, however brief. Specific examples of machine-readable media include non-volatile memory, including by way of example semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and CD-ROM and DVD-ROM disks.

The instructions 1924 may further be transmitted or received over a communications network 1926 using a transmission medium via the network interface device 1920 and utilizing any one of a number of well-known transfer protocols (e.g., FTP, HTTP). Examples of communication networks include a local area network (LAN), a wide area network (WAN), the Internet, mobile telephone networks, Plain Old Telephone (POTS) networks, and wireless data networks (e.g., WiFi and WiMax networks). The term “transmission medium” shall be taken to include any intangible medium that is capable of storing, encoding, or carrying instructions for execution by the machine, and includes digital or analog communications signals or other intangible medium to facilitate communication of such software.

### GENERAL

Thus, systems and methods to generate swimlane timeline diagrams with the Swimlane Timeline application have been described. Although the present inventive subject matter has been described with reference to specific example embodiments, it will be evident that various modifications and changes may be made to these embodiments without departing from the broader spirit and scope of the inventive subject matter. Such embodiments of the inventive subject matter may be referred to herein, individually or collectively, by the term “invention” merely for convenience and without intending to voluntarily limit the scope of this application to any single invention or inventive concept if more than one is, in fact, disclosed. The swimlane timeline may be implemented in various document object models, according to various example embodiments. While the Visio object model has been described herein, the inventive subject matter is not limited to only a Visio object model. Accordingly, the specification and drawings are to be regarded in an illustrative rather than a restrictive sense. Many other embodiments will be apparent to those of skill in the art upon review of the above description.

In this detailed description, reference is made to specific examples by way of drawings and illustrations. These examples are described in sufficient detail to enable those skilled in the art to practice the inventive subject matter, and serve to illustrate how the inventive subject matter can be applied to various purposes or embodiments. Other embodiments are included within the inventive subject matter, as logical, mechanical, electrical, and other changes can be made to the example embodiments described herein. Features or limitations of various embodiments described herein, however essential to the example embodiments in which they are incorporated, do not limit the inventive subject matter as a whole, and any reference to the invention, its elements, operation, and application are not limiting as a whole, but serve only to define these example embodiments. This detailed description does not, therefore, limit embodiments of the invention, which are defined only by the appended claims.

The Abstract is provided to comply with 37 C.F.R. §1.72(b) to allow the reader to quickly ascertain the nature and gist of the technical disclosure. The Abstract is submitted with the understanding that it will not be used to limit the scope of the claims.

Each of the embodiments described herein are contemplated as falling within the inventive subject matter, which is set forth in the following claims.

What is claimed is:

1. A method for transforming task data to an output swimlane timeline diagram, the method comprising:
receiving task data generated by a first application, the task data including data for one or more source tasks;
processing by one or more processors the task data in accordance with one or more of filters, group-by values, sort-by values or display preferences; and
generating a swimlane timeline diagram for the source tasks in accordance with the processed task data, and further in accordance with a diagramming software format.

2. The method of claim 1, wherein the diagramming software format is a version of the Microsoft Visio file format.

3. The method of claim 1, wherein generating the swimlane diagram includes using a diagramming software application programming interface (API).

4. The method of claim 1, wherein the diagramming software application programming interface is a version of the Microsoft Visio API.

5. The method of claim 1, wherein receiving task data includes receiving task data from one or more of a project file, spreadsheet file, or SharePoint file.

6. The method of claim 1, further comprising placing copies of the task data into an application cache buffer.

7. The method of claim 1, wherein generating a swimlane timeline diagram includes processing the source tasks according to task outline numbers associated with the source tasks.

8. The method of claim 7, wherein receiving task data includes reading a single source file having the task data, wherein the task outline numbers have the form “n1.n2.n3 . . . ” and wherein processing the task outline numbers includes:
receiving a user specified starting outline number and interpreting the user specified starting outline number n1 as a top level summary task for the swimlane timeline, and wherein the name of the top level summary task is specified as the name for the swimlane timeline title and wherein start and finish dates for the top level summary task are designated as the swimlane timeline start and finish dates;
interpreting the “n1.n2” tasks as swimlanes, wherein the “n1.n2” tasks are placed in a High Level Milestones swimlane and wherein the High Level Milestones are defined as tasks with zero duration; and
interpreting the “n1.n2.n3 . . . ” tasks as intervals and milestones displayed in the swimlanes.

9. The method of claim 1, wherein generating a swimlane timeline diagram includes processing the source tasks according to user specified filter-by, group-by, and sort-by fields.

10. The method of claim 9, wherein receiving task data includes reading a single or multiple source files having task data, wherein the fields associated with each task are read wherein processing the tasks includes:
receiving user specified group-by, filter-by, and sort-by fields;
interpreting the user specified group-by field values as the swimlanes, and the task filter-by values to determine the timeline start and finish dates, and the sort-by fields for determining the task ordering.

11. The method of claim 1, wherein receiving task data includes reading a plurality of source files, wherein the task outline numbers have the form “n1.n2.n3 . . . ” and wherein processing the task outline numbers includes:
receiving a user specified starting outline number “n1” and for each source file evaluating task data for outline number “n1” in the source file to determine the earliest start date and latest finish date over all tasks;
designating the earliest start date and the latest finish data as the start and finish date for a Portfolio View timeline;
determining a swimlane title for each swimlane based on the starting outline number task name for each source file; and
placing each source file's associated “n1.n2” interval and milestone tasks within their respective swimlane.

12. The method of claim 1, wherein processing the task data includes processing the task data according to user preferences expressed in task fields, the task fields including visibility color, visibility type and visibility short name fields.

13. The method of claim 1, wherein processing the task data includes processing the task data according to user preferences expressed in task fields, the task fields including Display task percent complete, Display task dependencies, Display timeline interval highlight, Display Today's date highlight, Filter timeline date range, and Filter task swimlanes to display fields.

14. The method of claim 1, and further comprising receiving data defining a user specified text size and color palette.

15. A system for transforming task data to a swimlane timeline diagram, the system comprising:
one or more processors;
one or more project data sources having task data, the project data generated by a first application, the task data including data for one or more source tasks;
a swimlane generation application operable to:
receive the task data;
process the task data in accordance with filters, group-by fields, sort-by fields and display preferences; and
generate a swimlane timeline diagram for the source tasks in accordance with the processed task data, and further in accordance with a diagramming software format.

16. The system of claim 15, wherein the diagramming software format is a version of the Microsoft Visio file format.

17. The system of claim 15, further comprising a diagramming software API for use to generate the swimlane timeline diagram.

18. The system of claim 17, wherein the diagramming software application programming interface is a version of the Microsoft Visio API.

19. The system of claim 15, wherein the project data sources include a project file, spreadsheet file, or a SharePoint file.

20. A machine-readable medium having instructions stored thereon for causing a processor to perform operations for transforming task data to an output swimlane timeline diagram, the operations comprising:
receiving task data generated by a first application, the task data including data for one or more source tasks;
processing the task data in accordance with filters, group-by values, sort-by values or display preferences; and
generating a swimlane timeline diagram for the source tasks in accordance with the processed task data, and further in accordance with a diagramming software format.
